(19) United States
(12) Patent Application Publication
(10) Pub. No.: US 2025/0049207 A1
(43) Pub. Date: Feb. 13, 2025

(54) ANTIMICROBIAL NYLON COMPOSITE MATERIAL, PREPARATION METHOD THEREOF AND APPLICATION IN BRUSHES

(71) Applicant: Guangzhou Aoqun Brush Industry Technology Co., Ltd, Guangzhou (CN)

(72) Inventors: Xuezhen Liu, Guangzhou (CN); Min Wang, Guangzhou (CN); Zhiqiang Liu, Guangzhou (CN)

(21) Appl. No.: 18/588,031

(22) Filed: Feb. 27, 2024

(30) Foreign Application Priority Data
Aug. 9, 2023 (CN) 202310993130.9

(51) Int. Cl. A46D 1/00; C08K 3/015; C08K 3/08; C08K 7/06; C08K 7/28; C08L 77/06; D01F 1/10; D01F 6/90

(52) U.S. Cl. CPC A46D 1/006; A46D 1/0207; C08K 3/015; C08K 3/08; C08K 7/06; C08K 7/28; C08L 77/06; D01F 1/103; D01F 6/90; C08K 2003/0806; C08L 2205/025

(57) ABSTRACT

Disclosed are an antimicrobial nylon composite material, a preparation method thereof and an application in brushes. The antimicrobial nylon composite material includes a nylon matrix material, an antimicrobial agent, a reinforcing agent, and a plant material. The plant material includes tea tree essential oil, clove oil and eucalyptus essential oil. In the present disclosure, the growth and reproduction of bacteria can be effectively inhibited by using a silver ion antimicrobial agent and the plant material, thereby providing a stronger antimicrobial property. Meanwhile, the mechanical strength and wear resistance of the material can be significantly improved by introducing the reinforcing agent, a fiber reinforcing agent and a particle reinforcing agent into a nylon matrix to make the manufactured brush have a longer service life and better performance.

### CROSS-REFERENCE TO RELATED APPLICATIONS

This application claims priority of Chinese Patent Application No. 202310993130.9, filed on Aug. 9, 2023, the entire contents of which are incorporated herein by reference.

### TECHNICAL FIELD

The present disclosure relates to the technical field of nylon composite materials, in particular to an antimicrobial nylon composite material, a preparation method thereof and an application in brushes.

### BACKGROUND

At present, daily necessities such as brushes are prone to germinate bacteria during use, thereby bringing certain risks to people's health. In order to solve the problem, a method of manufacturing a brush using an antimicrobial material has been proposed. However, the existing antimicrobial materials have certain deficiencies, and the preparation method is also complicated, mainly having two technical problems:

(1) Poor antimicrobial property: the brush often contacts with a large amount of dust and bacteria for a long time, which is prone to store bacteria and other microorganisms and spread bacterial infections; and therefore, there is a need to use antimicrobial materials in the manufacture of brushes to effectively inhibit bacterial plaques and bacteria breeding and improve the hygienic quality of the product.

(2) Lack of wear resistance: brushes are usually cleaned by brushing, and therefore the brush has a short service life, which cannot meet the requirements for long-term use; and if the wear resistance of the brush can be improved, the service life can be greatly prolonged, the cost can be reduced and the user's satisfaction can be improved.

Therefore, it is necessary to propose a novel antimicrobial nylon composite material and a preparation method thereof, to improve the application in brushes.

### SUMMARY

An object of the present disclosure is to provide an antimicrobial nylon composite material, a preparation method thereof and an application in brushes to solve the problems set forth in the above background.

In order to achieve the above object, in one aspect, the present disclosure provides an antimicrobial nylon composite material, including the following raw materials:
a nylon matrix material, accounting for 50-90% of a total volume,
an antimicrobial agent, accounting for 1-5% of the total volume,
a reinforcing agent, accounting for 5-40% of the total volume, and
a plant material, accounting for 1-5% of the total volume,
the plant material including tea tree essential oil, clove oil and eucalyptus essential oil in a weight ratio of 1:1:1.

As a further improvement of the technical solution, the nylon matrix material is selected from one of nylon 6, nylon 66 and nylon 12.

As a further improvement of the technical solution, the antimicrobial agent is a silver ion antimicrobial agent having a purity higher than 99%.

As a further improvement of the technical solution, the reinforcing agent includes a fiber reinforcing agent and a particle reinforcing agent in a weight ratio of 1:1.

As a further improvement of the technical solution, the fiber reinforcing agent is at least one of a glass fiber and a carbon fiber.

As a further improvement of the technical solution, the particle reinforcing agent is at least one of wollastonite and metal particles.

As a further improvement of the technical solution, a preparation method for the plant material includes the steps of:
S1. 1, taking branches and leaves of tea tree, clove and eucalyptus to clean and dry for later use;
S1. 2, adding the above materials into three mortars separately, uniformly stirring the same by stirring rods, and then adding the same into extractors separately, and adding alcohol for extraction; and
S1. 3, screening the extracted tea tree extract, clove extract and eucalyptus extract for centrifuging to remove impurities, and then performing concentration, and finally uniformly stirring the three materials by using an ultrasonic dispersion machine to prepare the plant material.

In another aspect, the present disclosure provides a preparation method for an antimicrobial nylon composite material of any of the above, including the steps of:
S2. 1, adding a nylon matrix material, an antimicrobial agent and a reinforcing agent into a high-shear mixer for continuous and efficient mixing;
S2. 2, adding a plant material after the above materials are uniformly mixed, and mixing all materials to form a molding material; and
S2. 3, extruding and pelletizing the molding material with an extruder to prepare an antimicrobial nylon composite material.

Preferably, in S2. 3, an extrusion temperature of the extruder is 220-250° C.

The antimicrobial nylon composite material prepared by the present disclosure can be applied in brushes.

Compared with the prior art, the present disclosure has the following beneficial effects.

1. In the present disclosure, the growth and reproduction of bacteria can be effectively inhibited by using the silver ion antimicrobial agent and the plant material, thereby providing a stronger antimicrobial property, which is of great significance in applications, such as brushes, that need to maintain hygiene and prevent the spread of bacteria. Meanwhile, the mechanical strength and wear resistance of the material can be significantly improved by introducing the reinforcing agent, the fiber reinforcing agent and the particle reinforcing agent into a nylon matrix to make the composite material more robust and durable and to make the manufactured brush have a longer service life and better performance.

2. In the present disclosure, the brush made of the antimicrobial nylon composite material has good low friction performance and wear resistance performance, which can effectively reduce the wear degree and maintenance cost of the brush during use, and also has better hygienic performance, thereby greatly improving the use efficiency and service life of the brush.

### BRIEF DESCRIPTION OF THE DRAWINGS

FIG. 1 is an overall flow block diagram of the present disclosure.

### DETAILED DESCRIPTION

Technical solutions in the examples of the present disclosure will be described clearly and completely in the following with reference to the attached drawings in the examples of the present disclosure. Obviously, all the described examples are only some, rather than all examples of the present disclosure. Based on the examples in the present disclosure, all other examples obtained by those skilled in the art without creative efforts belong to the scope of protection of the present disclosure.

An example of the present disclosure provides an antimicrobial nylon composite material, including the following raw materials:
a nylon matrix material, accounting for 50-90% of a total volume,
an antimicrobial agent, accounting for 1-5% of the total volume,
a reinforcing agent, accounting for 5-40% of the total volume, and
a plant material, accounting for 1-5% of the total volume.

The nylon matrix material is selected from one of nylon 6, nylon 66 and nylon 12, and has advantages of high strength, corrosion resistance and vibration resistance.

The antimicrobial agent is a silver ion antimicrobial agent having a purity higher than 99%, which can inhibit biodegradation and effectively prolong the service life of the material. The antimicrobial mechanism of silver ions is that the bacteria are killed by destroying cell walls. Electrostatic attraction occurs between the silver ion antimicrobial agent and a nylon matrix, forming precipitates, and the silver ions are adsorbed on a surface of the nylon matrix material, thereby forming the antimicrobial property.

The reinforcing agent includes a fiber reinforcing agent and a particle reinforcing agent in a weight ratio of 1:1.

The strength and stiffness of the material can be improved by the composite action of the fiber reinforcing agent and the nylon matrix material. The fiber reinforcing agent is at least one of a glass fiber and a carbon fiber, and its diameter is controlled to be 10 μm or less, and its length is between 1-10 mm. During hardening, covalent bond reaction occurs between the fiber reinforcing agent and the nylon matrix, thereby improving the strength.

The hardness and strength of the material can be increased by the composite action of the particle reinforcing agent and the nylon matrix material. The particle reinforcing agent is at least one of wollastonite and metal particles. The particle reinforcing agent can play the role of filler between nylon matrix materials, new chemical bonds may be formed in the materials and the interaction between molecules is enhanced, thereby improving the hardness, strength and toughness of the material.

The plant material is prepared by mixing a plurality of plant materials. The plant material includes tea tree essential oil, clove oil and eucalyptus essential oil, in a weight ratio of 1:1:1. A purity of the tea tree essential oil is higher than 70%, a purity of the clove essential oil is higher than 85%, and a purity of the eucalyptus essential oil is higher than 90%. The plant material, made by mixing various plant materials, has a broad-spectrum antimicrobial effect and can effectively kill various bacteria, fungi and other microorganisms, thereby achieving a good antimicrobial effect. Active ingredients contained in tea tree essential oil, clove oil and eucalyptus essential oil can penetrate cell membranes and destroy cell walls, thereby leading to cell death. Meanwhile, these plant essential oils also have good anti-oxidation and anti-necrosis effects, which can protect the materials from natural oxidation and reduce the damage of other chemical substances to the materials. In addition, the plant material, having certain aromas, can make the material emit fragrant odors when in use, improving the added value of products and meet the continuous improvement of consumers' needs for health, environmental protection and other aspects. A specific preparation method of the plant material is as follows.

(1) Branches and leaves of tea tree, clove and eucalyptus are taken to clean and dry for later use.

(2) The above materials are added into three mortars separately, uniformly stirred by stirring rods, and then added into extractors separately, and alcohol is added for extraction.

(3) The extracted tea tree extract, clove extract and eucalyptus extract are screened for centrifuging to remove impurities, and then concentration is performed, and finally the three materials are uniformly stirred by using an ultrasonic dispersion machine to prepare the plant material.

When a composite material is prepared, the silver ion antimicrobial agent can also be mixed into the plant material to form a bactericide; and the antimicrobial capacity can be further enhanced by the additive action between silver ions and plant components.

In the present disclosure, compared with the traditional nylon composite material, the growth and reproduction of bacteria can be effectively inhibited by using a silver ion antimicrobial agent and the plant material, thereby providing a stronger antimicrobial property, which is of great significance in applications, such as brushes, that need to maintain hygiene and prevent the spread of bacteria. Meanwhile, the mechanical strength and wear resistance of the material can be significantly improved by introducing the reinforcing agent, a fiber reinforcing agent and a particle reinforcing agent into a nylon matrix to make the composite material more robust and durable and to make the manufactured brush have a longer service life and better performance.

Meanwhile, the brush made of the antimicrobial nylon composite material also has good low friction performance and wear resistance performance, which can effectively reduce the wear degree and maintenance cost of the brush during use, and at the same time has better hygienic performance, thereby greatly improving the use efficiency and service life of the brush.

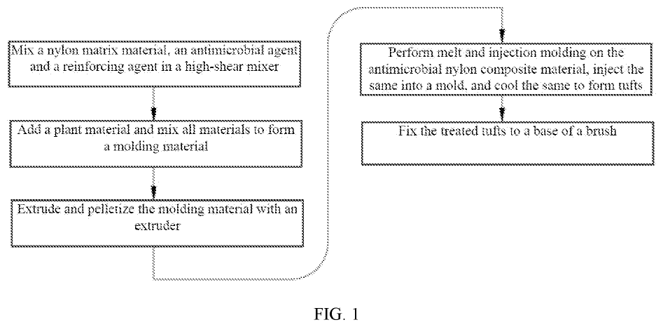

As shown in FIG. 1, examples of the present disclosure further provide a preparation method for an antimicrobial nylon composite material and a method for manufacturing a brush, and the specific steps are as follows.

### I. Preparation of Nylon Composite Material

(1) A nylon matrix material, an antimicrobial agent and a reinforcing agent are added into a high-shear mixer for continuous and efficient mixing for a treatment time of 50-60 s.

(2) A plant material is added after the above materials are uniformly mixed, and all materials are mixed to form a molding material.

(3) The molding material is extruded and pelletized with an extruder at an extrusion temperature of 220-250° C. to prepare an antimicrobial nylon composite material.

### II. Manufacture of Brush

(1) The antimicrobial nylon composite material is melt-spun to prepare a brush filament material for the brush production; and the antimicrobial nylon composite material is put into an injection molding machine, melted and injected into a mold, cooled and formed, with a mold temperature of 45-60° C. and a linear velocity of 8-10 m/min, to prepare some tufts suitable for a brush. The pulling resistance of the brush filament can be improved and the loss of fly is reduced.

(2) The prepared brush filament material (filaments or tufts) is input into a full-automatic brush manufacturing device, the operations such as blanking, forming, fastening, flying and length cutting are automatically completed, and the high-performance and high-precision brush required by a user is output.

The preparation method of the present disclosure is relatively simple and involves the steps of the mixing of the nylon matrix with the antimicrobial agent, melt processing, the addition of reinforcing agents, cooling and curing. Compared with preparation methods for other composite material, the method is simple in operation, does not require a complex device and process, reduces the preparation cost and improves the production efficiency.

The antimicrobial nylon composite material provided by the present disclosure is further illustrated by the following specific examples according to different dosage of raw materials.

### Example 1

(1) A nylon matrix material accounting for 50% of a total volume, an antimicrobial agent accounting for 5% of the total volume and a reinforcing agent accounting for 5% of the total volume were added into a high-shear mixer for continuous and efficient mixing for a treatment time of 50 s.

(2) A plant material accounting for 5% of the total volume was added after the above materials were uniformly mixed, and all materials were mixed to form a molding material.

(3) The molding material was extruded and pelletized with an extruder at an extrusion temperature of 220° C. to prepare an antimicrobial nylon composite material.

(4) The extruded material was put into an injection molding machine, melted and injected into a mold, cooled and formed, with a mold temperature of 45° C. and a linear velocity of 8 m/min, to prepare some tufts suitable for a brush.

### Example 2

(1) A nylon matrix material accounting for 70% of a total volume, an antimicrobial agent accounting for 3% of the total volume and a reinforcing agent accounting for 25% of the total volume were added into a high-shear mixer for continuous and efficient mixing for a treatment time of 55 s.

(2) A plant material accounting for 2% of the total volume was added after the above materials were uniformly mixed, and all materials were mixed to form a molding material.

(3) The molding material was extruded and pelletized with an extruder at an extrusion temperature of 230° C. to prepare an antimicrobial nylon composite material.

(4) The extruded material was put into an injection molding machine, melted and injected into a mold, cooled and formed, with a mold temperature of 55° C. and a linear velocity of 9 m/min, to prepare some tufts suitable for a brush.

### Example 3

(1) A nylon matrix material accounting for 90% of a total volume, an antimicrobial agent accounting for 1% of the total volume and a reinforcing agent accounting for 5% of the total volume were added into a high-shear mixer for continuous and efficient mixing for a treatment time of 60 s.

(2) A plant material accounting for 4% of the total volume was added after the above materials were uniformly mixed, and all materials were mixed to form a molding material.

(3) The molding material was extruded and pelletized with an extruder at an extrusion temperature of 250° C. to prepare an antimicrobial nylon composite material.

(4) The extruded material was put into an injection molding machine, melted and injected into a mold, cooled and formed, with a mold temperature of 60° C. and a linear velocity of 10 m/min, to prepare some tufts suitable for a brush.

### Example 4

(1) A nylon matrix material accounting for 60% of a total volume, an antimicrobial agent accounting for 2% of the total volume and a reinforcing agent accounting for 35% of the total volume were added into a high-shear mixer for continuous and efficient mixing for a treatment time of 55 s.

(2) A plant material accounting for 3% of the total volume was added after the above materials were uniformly mixed, and all materials were mixed to form a molding material.

(3) The molding material was extruded and pelletized with an extruder at an extrusion temperature of 230° C. to prepare an antimicrobial nylon composite material.

(4) The extruded material was put into an injection molding machine, melted and injected into a mold, cooled and formed, with a mold temperature of 50° C. and a linear velocity of 8 m/min, to prepare some tufts suitable for a brush.

### Example 5

(1) A nylon matrix material accounting for 80% of a total volume, an antimicrobial agent accounting for 4% of the total volume and a reinforcing agent accounting for 15% of the total volume were added into a high-shear mixer for continuous and efficient mixing for a treatment time of 60 s.

(2) A plant material accounting for 1% of the total volume was added after the above materials were uniformly mixed, and all materials were mixed to form a molding material.

(3) The molding material was extruded and pelletized with an extruder at an extrusion temperature of 240° C. to prepare an antimicrobial nylon composite material.

(4) The extruded material was put into an injection molding machine, melted and injected into a mold, cooled and formed, with a mold temperature of 55° C. and a linear velocity of 10 m/min, to prepare some tufts suitable for a brush.

TABLE 1
Dosage of raw materials in Examples 1-5

| | Example 1 | Example 2 | Example 3 | Example 4 | Example 5 |
|---|---|---|---|---|---|
| Nylon matrix | 50 | 70 | 90 | 60 | 80 |
| material (%) | | | | | |
| Antimicrobial | 5 | 3 | 1 | 2 | 4 |
| agent (%) | | | | | |
| Reinforcing | 40 | 25 | 5 | 35 | 15 |
| agent (%) | | | | | |
| Plant material | 5 | 2 | 4 | 3 | 1 |
| (%) | | | | | |

In order to verify that the nylon composite materials prepared in the examples of the present disclosure had good antimicrobial property and practicality, the antimicrobial nylon composite materials provided in the examples of the present disclosure were illustrated by the following experimental examples.

### Experimental Example 1

In the experimental example, the nylon composite materials provided in Examples 1-5 and a commercially available common nylon material (Comparative Example) were subjected to antimicrobial tests.

The test method was as follows.

(1) Preparation of test strains: Escherichia coli (E. coli) and Staphylococcus aureus (S. aureus) were selected for testing, taken from frozen bacteria, and amplified by liquid culture.

(2) Preparation of test samples: samples of the nylon composite materials provided in Examples 1-5 and samples of commercially available common nylon materials were prepared, with a sample size of 200 mm in length, 20 mm in width and 2 mm in thickness.

(3) The test strains were inoculated on the samples separately, and the samples were put in culture dishes for culture for 24 h; and the cultured colonies were counted, and antimicrobial rates were calculated by antimicrobial effects.

Specific detection indicators were shown in Table 2.

TABLE 2

| | | | | | | Comparative |
|---|---|---|---|---|---|---|
| | Example 1 | Example 2 | Example 3 | Example 4 | Example 5 | Example |
| Antimicrobial rate | 99.1 | 99.7 | 99.4 | 99.5 | 99.1 | 61.3 |
| against E. coli (%) | | | | | | |
| Antimicrobial rate | 99.3 | 99.5 | 99.1 | 99.6 | 99.5 | 62.8 |
| against S. aureus | | | | | | |
| (%) | | | | | | |

As shown in Table 2, after 24 h of culture, the antimicrobial nylon composite materials provided in Examples 1-5 had very obvious antimicrobial effects, with the antimicrobial rates against E. coli and S. aureus reaching 99% or more; and the common nylon material had a low antimicrobial rate, with the antimicrobial rates against E. coli and S. aureus being only about 60%, and was prone to germinate bacteria and produce odor after long-term use. In contrast, the odor-free and plaque-free properties of the antimicrobial nylon composite material provided by the present disclosure were more desirable for various applications.

### Experimental Example 2

In the experimental example, the nylon composite materials provided in Examples 1-5 and a commercially available common nylon material (Comparative Example) were applied on brushes and then subjected to comparative tests.

The test method was as follows.

(1) Preparation of test samples: the manufactured antimicrobial nylon composite materials (Examples 1-5) and the commercially available common nylon material (Comparative Example) were manufactured to form brush samples.

(2) Service life testing: the brush samples were used to brush kitchen and bathroom appliances for 2 h per day for 1 month; and during this period, the brushes were washed once a week, and two kinds of brushes were subjected to antimicrobial tests, namely E. coli and S. aureus.

Specific detection indicators were shown in Table 3.

TABLE 3

| | | | | | | Comparative |
|---|---|---|---|---|---|---|
| | Example 1 | Example 2 | Example 3 | Example 4 | Example 5 | Example |
| Antimicrobial rate | 94.7 | 93.1 | 94.3 | 92.9 | 93.5 | 52.9 |
| against E. coli (%) | | | | | | |
| Antimicrobial rate | 95.6 | 92.7 | 93.3 | 93.5 | 94.1 | 51.3 |
| against S. aureus | | | | | | |
| (%) | | | | | | |

As shown in Table 3, the brushes made of the antimicrobial nylon composite material provided in Examples 1-5 still had good antimicrobial property after the tests. However, the brushes made of the common nylon material produced many bacterial plaques during use and after a long period of use, and the antimicrobial effect was rapidly reduced. Therefore, the possibility of daily bacterial infection can be effectively reduced, and the hygiene and health of families and public places are ensured by using the brushes made of the antimicrobial nylon composite material prepared by the present disclosure.

The basic principle, main features and advantages of the present disclosure have been shown and described above. It is to be understood by those skilled in the art that the present disclosure is not limited by the above examples. The above examples and descriptions are only preferred examples of the present disclosure and are not used to limit the present disclosure. Without departing from the spirit and scope of the present disclosure, there will be various changes and improvements in the present disclosure, which fall within the scope of the claimed disclosure. The scope of protection claimed by the present disclosure is defined by the appended claims and equivalents thereof.

1. An antimicrobial nylon composite material, comprising the following raw materials:
a nylon matrix material, accounting for 50-90% of a total volume,
an antimicrobial agent, accounting for 1-5% of the total volume,
a reinforcing agent, accounting for 5-40% of the total volume, and
a plant material, accounting for 1-5% of the total volume,
the plant material comprising tea tree essential oil, clove oil and eucalyptus essential oil in a weight ratio of 1:1:1,
the nylon matrix material being selected from one of nylon 6, nylon 66 and nylon 12,
the antimicrobial agent being a silver ion antimicrobial agent having a purity higher than 99%, and
the reinforcing agent comprising a fiber reinforcing agent and a particle reinforcing agent in a weight ratio of 1:1,
the fiber reinforcing agent being at least one of a glass fiber and a carbon fiber, and
the particle reinforcing agent being at least one of wollastonite and metal particles,
antimicrobial rates of the antimicrobial nylon composite material against Escherichia coli (E. coli) and Staphylococcus aureus (S. aureus) reaching 99% or more.

2. The antimicrobial nylon composite material according to claim 1, wherein a preparation method for the plant material comprises the steps of:
S1. 1, taking branches and leaves of tea tree, clove and eucalyptus to clean and dry for later use;
S1. 2, adding the above materials into three mortars separately, uniformly stirring the same by stirring rods, and then adding the same into extractors separately, and adding alcohol for extraction; and
S1. 3, screening the extracted tea tree extract, clove extract and eucalyptus extract for centrifuging to remove impurities, and then performing concentration, and finally uniformly stirring the three materials by using an ultrasonic dispersion machine to prepare the plant material.

3. A preparation method for an antimicrobial nylon composite material according to claim 1, comprising the steps of:
S2. 1, adding a nylon matrix material, an antimicrobial agent and a reinforcing agent into a high-shear mixer for continuous and efficient mixing;
S2. 2, adding a plant material after the mixing in step S2. 1 is uniform, and mixing all materials to form a molding material; and
S2. 3, extruding and pelletizing the molding material with an extruder to prepare an antimicrobial nylon composite material.

4. The preparation method for an antimicrobial nylon composite material according to claim 3, wherein in S2. 3, an extrusion temperature of the extruder is 220-250° C.

5. An application of an antimicrobial nylon composite material according to claim 1 in brushes.
